(19) United States
(12) Patent Application Publication
(10) Pub. No.: US 2011/0283341 A1
(43) Pub. Date: Nov. 17, 2011

(54) Facilitating Secure Communications

(76) Inventor: Nikhil Sanjay Palekar, Arlington, VA (US)

(21) Appl. No.: 13/106,799

(22) Filed: May 12, 2011

Related U.S. Application Data
(60) Provisional application No. 61/334,574, filed on May 13, 2010.

(51) Int. Cl. G06F 21/00; G06F 15/16

(52) U.S. Cl. 726/4

(57) ABSTRACT

The claimed subject matter provides systems and methods for facilitating secure communications. The disclosed systems and methods can include components for receiving and processing user authentication information from users or other systems to selectively provide access to stored information. The stored information may be displayed on or accessed via interfaces that interact with components of the system. An embodiment provides for identifying an authentication framework to verify authentication data, authenticating a user using the identified authentication framework, receiving message data associated with at least one communications message, generating at least one outgoing message in response to the received message data, wherein the outgoing message differs from the received communications message, and providing access to content associated with the at least one communications message.

### REFERENCE TO RELATED APPLICATIONS

This application claims the benefit of U.S. Provisional Patent Application Ser. No. 61/334,574, filed May 13, 2010, and entitled SYSTEMS AND METHOD FOR FACILITATING SECURE COMMUNICATIONS, the entirety of which is incorporated herein by reference.

### TECHNICAL FIELD

This invention relates to the field of secure electronic messaging and communications using computer networks.

### RELATED ART

Traditional communications systems that operate over shared channels such as the Internet are inherently insecure because they operate using insecure network links and insecure data-transfer protocols. Because these communications channels are not secure, the confidentiality or integrity of the communications information may be compromised while the information is in transit. Some systems designed to provide secure communications do so by exchanging encryption keys, but that process is both cumbersome and ineffective, as all users involved in the communications session have to share some knowledge about each other and have a working technical knowledge of key-exchange systems to implement such a system. Other systems password protect the message itself; however, the password still has to be communicated separately to the recipient. Still other systems require users to create new accounts for sending and receiving communications messages through the system.

### SUMMARY

An embodiment of the present invention provides a secure communications system that authenticates senders and recipients of communications messages to ensure that the messages are transmitted securely from the sender to the recipient. Each user may be authenticated independently. In an embodiment, at least one of the users already has authentication credentials associated with at least one third-party system that may be used to authenticate the user. Messages sent and received using the messaging system further may be incorporated into the user's existing email account with other message content.

In some embodiments, the communications system also may provide a variety of interfaces through which users interact with the system. These interfaces facilitate access to message data after the user has provided valid authentication credentials to the communications system. Thus, a user may specify that a message should expire after a certain amount of time, or a user may permanently delete all related copies or representations of the message if the information contained therein is no longer needed. In one embodiment, the communications system is configured to function like a traditional email server that interfaces with a desktop email client. Users may manage messages and initiate communications through the desktop email client, as with traditional email systems. In another embodiment, the communications system provides a web-based interface for users initiating or responding to communications messages via the communications system. The communications system also may provide account management services for users as part of the user interface.

According to another embodiment for facilitating secure communications, a device may comprise a memory configured to store at least one data packet and a processor operatively coupled to the memory and configured to identify an authentication framework to verify authentication data, authenticate a user using the identified authentication framework, securely receive message data associated with at least one communications message, generate at least one outgoing message based at least in part on the received communications message, wherein the outgoing message differs from the received communications message, and provide secure access to content associated with the at least one communications message.

In another exemplary embodiment, identifying an authentication framework comprises determining whether the user authentication data is associated with a local account or an external account. According to another embodiment, authenticating the user authentication data comprises forwarding the user authentication data to an external authentication server, and receiving an authentication determination from the external authentication server. In another embodiment, receiving an authentication determination comprises establishing a secure connection with the user based at least in part on the verified authentication data.

In another exemplary embodiment the outgoing message is configured to include a hyperlink to facilitate access to the at least one communications message. Another embodiment further comprises processing a request associated with content in the outgoing message. In another exemplary embodiment, processing a request further comprises determining whether authentication information associated with a second user has been received, generating content associated with the outgoing message based at least in part on an authentication status of the second user, and securely transmitting the generated content. In another exemplary embodiment, identifying an authentication framework comprises processing at least one of a user name or email address.

### BRIEF DESCRIPTION OF THE DRAWINGS

FIG. 1 is a block diagram of an exemplary embodiment of a secure communications system.

FIG. 2 is a block diagram of an exemplary embodiment of an authentication module of a secure communication system.

FIG. 3 is a block diagram of an exemplary embodiment of a messaging component of a secure communication system.

FIG. 4 is a block diagram of an exemplary federated communications system in accordance with an embodiment of the present invention.

FIG. 5 is a flowchart illustrating an exemplary process for managing secure communications in accordance with the present invention.

FIG. 6 shows a computer network system and environment in accordance with an embodiment of the invention.

### DETAILED DESCRIPTION

The present invention is now described with reference to the drawings, wherein like reference numerals are used to refer to like elements throughout. In the following description, numerous specific details may be set forth to provide a thorough understanding of one or more embodiments of the invention, but in some instances embodiments of the invention may be practiced without these specific details. In other instances, well-known structures and devices are shown in block diagram form in order to facilitate describing one or more embodiments of the invention.

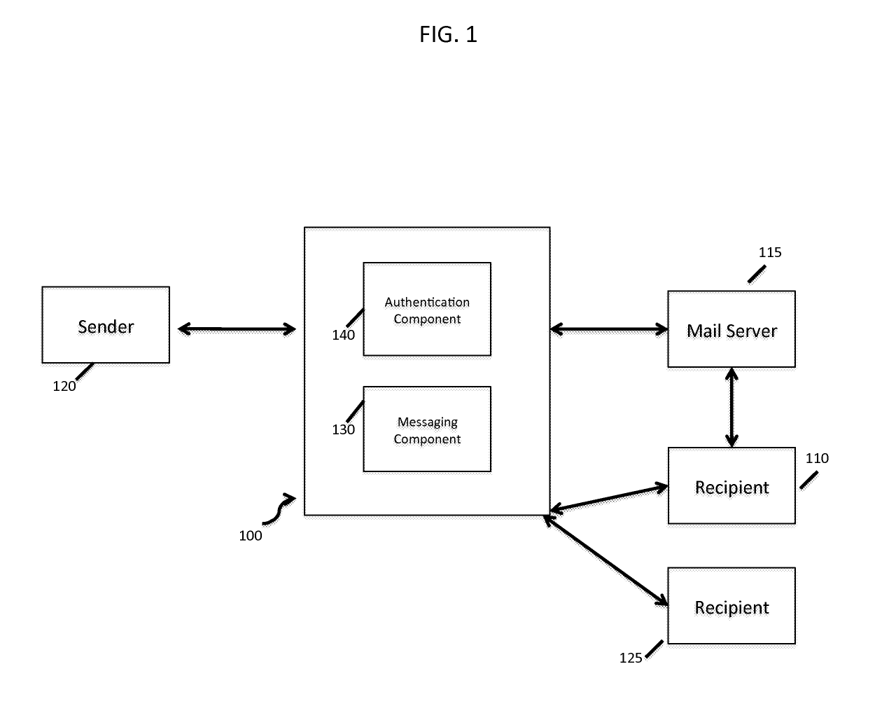

An exemplary communications system 100 is illustrated in FIG. 1. In one embodiment, the communications system 100 facilitates communications between at least one recipient 110 or recipient 125 and one sender 120. In one example, recipient 110 and sender 120 may interact with communications system 100 using mobile computing devices or personal computing devices operatively connected to a computer network, such as the Internet. In one embodiment, the communications system 100 comprises an interface component 130 and an authentication component 140. The system 100 is capable of operating using a variety of standard email and communications protocols including Simple Mail Transport Protocol (SMTP), Internet Access Message Protocol (IMAP), HyperText Transfer Protocol (HTTP), and secure variants thereof that implement the Secure Socket Layer (SSL) or Transport Layer Security (TLS) protocols to encrypt communications between systems. Secure communications occur over a specified port using a specified encryption algorithm to establish a secure communications channel for transmitted information. It is to be understood that components of communications system 100 may be implemented on different computing devices operatively coupled to perform functions, as disclosed herein.

In one embodiment, a messaging component 130 manages communications received and transmitted by the system 100. For example, messaging component 130 may be configured to handle communications messages received from the sender 120. In one embodiment, the messaging component 130 may analyze the contents of the message to classify the communications message. For example, a particular message may include an identifier signaling that the communications message should be classified according to the attached data files included as part of the communications message. In an exemplary embodiment, the messaging component 130 may encrypt the message after receiving it from the sender 120 but before it stores the message in a database.

In another embodiment, the messaging component 130 sends a message to the recipient 110 in response to receipt of a communications message from the sender 120 via mail server 115. Mail server 115 may be an external server with which communications system is operatively connected and configured to communicate via a computer network, and mail server 115 may be configured to process email and other network communications as well known in the art. For example, the messaging component 130 may send a notification message to the recipient 110 that may contain information associated with the sender's original message. In one embodiment, the notification message may include identifying information about the source of the original message and a way for the recipient 110 to access the original message. In another embodiment, the notification message provides access to secure content that may be delivered dynamically if the recipient 110 has already been authenticated by system 100. The messaging component 130 sends the notification message to the recipient 110 via the mail server 115 using traditional protocols for email communications listed herein, such as SMTP, without compromising the security and confidentiality of the original message. Recipient 110 may communicate with mail server 115 using well-known methods and protocols to retrieve the notification message. In another embodiment, recipient 125 may be configured to communicate directly with messaging component 130.

The messaging component 130 also provides a messaging and management interface that users may use to view and manage communications. The messaging component 130 may provide different views of the items accessible to the user, and in one embodiment, the messaging component 130 may include various display options that provide different views of content. Also, the messaging component 130 may be configured to display different messaging items differently within the interface. In addition, the messaging component 130 may be configured to display the items in the interface according to saved preferences or input from the user or based on message attributes or message type. Such preferences may pertain to sorting, labeling, or other organizational options. In one embodiment, the recipient 110 may access the individual message associated with his/her notification message without viewing the complete messaging interface. In this manner, the recipient 110 may take various actions in response to the message, including replying, retrieving any attached files, or deleting the message. This list of actions is merely exemplary and not exhaustive of all actions available to the recipient 110 using the interface.

An authentication component 140 authenticates the sender 120 before allowing access to the system. The sender 120 may authenticate with the communications system 100 in various ways, but in an exemplary embodiment, the sender 120 interfaces with the system 100 using a web interface displayed as a web page on a display device connected with the sender's device. In another embodiment, the sender 120 may authenticate with the communications system 100 using an email client software program installed on the sender's device that is configured to communicate securely with the communications system 100. The authentication component 140, thus, establishes a secure connection between the system 100 and the sender 120 before communications data is exchanged. If the sender 120 has been authenticated, the communications system 100 may be configured to process and securely store the message received from the sender 120.

The authentication component 140 also authenticates the recipient 110 before granting access to the sender's original message. In an exemplary embodiment, the recipient 110 receives a notification message and attempts to retrieve the original message sent by sender 120. The authentication component 140 requires that the recipient 110 provide valid login credentials before providing access to the content of the sender's original message. In one embodiment, the recipient 110 uses a set of credentials that includes a user name and password to authenticate and establish a secure connection between the system 100 and the recipient 110. If the authentication component 140 determines that the recipient 110 has been authenticated, it may provide access to the sender's original message or a representation thereof.

In another embodiment, the authentication component 140 determines whether the recipient 110 has been authenticated in response to a request for content related to the notification message. For example, a device associated with recipient 110 may request content included in the notification message that is accessible only to users that are already authenticated to access resources associated with system 100. If the authentication component 140 determines that the recipient 110 has been properly authenticated, message content delivered in response to the content request may include secure content.

As will be discussed in further detail below, the authentication component 140 may accept a number of different forms of credentials that generally allow the recipient 110 to authenticate using existing authentication credentials that were not generated by the communications system 100. If the authentication component 140 validates the login credentials provided by recipient 110, the system 100 may allow the recipient 110 to access secure content.

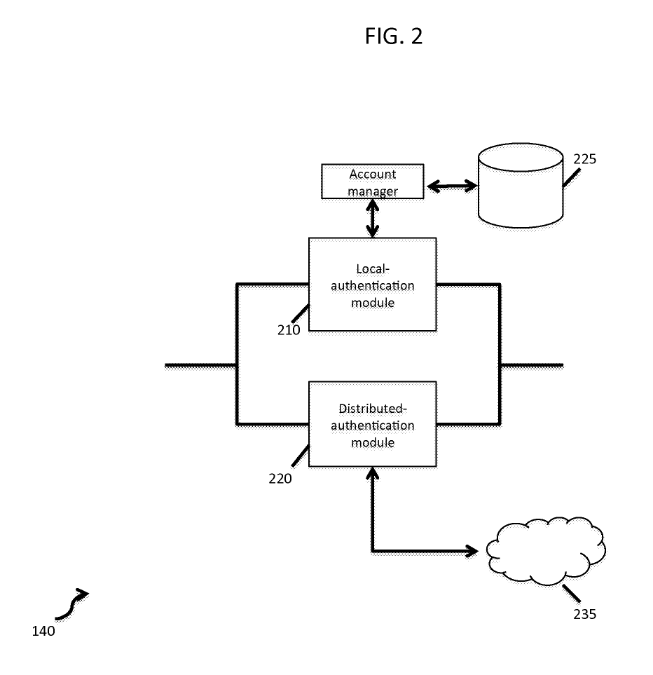

FIG. 2 is a block diagram of an exemplary embodiment of the authentication component 140. The example authentication component 140 includes a local-authentication module (LM) 210, an account manager component 220, and distributed-authentication module (DM) 230. As previously described herein, senders and recipients of communications messages authenticate to authentication component 140 before accessing the resources of the system 100. More generally, any user attempting to access the system 100 provides valid login credentials in order to gain access. The authentication component 140 may automatically use any number of authentication modules to verify the identity of the user attempting to access the system 100. In one embodiment, LM 210 may verify the login credentials provided if they are associated with an account that was created and stored by an account manager component 220. In particular, the account manager 220 may access a database 225 to verify the local credentials provided by the user. In another embodiment, DM 230 verifies the credentials provided from a user even if the user is associated with a system other than system 100. In one embodiment, the user maybe associated with a different system accessible via network 235. For example, a user may provide login credentials as a user-name and password pair, such as “user@externalsite.com” and “password,” and the DM 230 attempts to authenticate the user based on those credentials. In a particular embodiment, the DM 230 provides for authentication with other systems that implement an authentication framework. For example, an external system may implement or interface with OpenID, OAuth, LiveID, Kerberos, LDAP, Active Directory, SAML, or other authentication frameworks. The DM 230 may interface with an external system to verify the credentials of the user using one of these frameworks. In one embodiment, DM 230 may determine an authentication framework that corresponds to the authentication credentials supplied by the user and may initiate an authentication request to that framework. DM 230 may be further configured to process an authentication outcome from the identified authentication framework to complete an authentication process to facilitate access to communications system 100 for the user. The LM 210 and the DM 230 may communicate with other components within the system 100 or external frameworks using a variety of communications protocols, including protocols discussed previously herein, XML-based protocols such as the Extensible Messaging and Presence Protocol (XMPP), or other protocols well known in the art. The DM 230 also may require additional authentication information before granting the user access to the system 100. For example, the DM 230 may verify the email address associated with the user-name, or the DM 230 may prompt the user for more information. In one embodiment, the DM 230 or the LM 210 may present the user with a challenge that must be answered to complete the authentication process. The challenge may be in the form of one or more questions or prompts that require one or more inputs from the user.

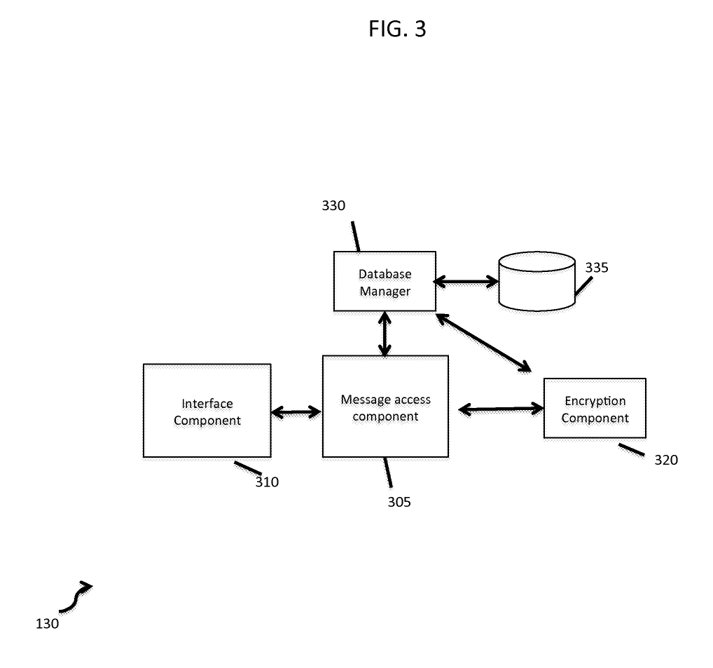

FIG. 3 is a block diagram of an exemplary embodiment of the messaging component 130. This exemplary embodiment of messaging component 300 includes an interface component 310, a message access component (MAC) 305, an encryption component 320, a database manager 330, and database storage units 335. As discussed previously, the messaging component 130 processes incoming and outgoing messages. An interface component 310 handles interactions with users and, in one embodiment, provides a graphical user interface for the user. For example, users may view content using a web-based interface generated by the interface component 310. In one embodiment, an authenticated user attempting to retrieve a message may use a hyperlink displayed as part of the web-based interface to access a particular message. In an embodiment, features of messaging component 130 may be implemented as a code snippet, such as JavaScript, configured to operate on a user device to request and display data from communications system 100.

If a user has not yet been authenticated, the interface component 310 may present the user with an authentication interface before displaying secure content. In one embodiment of the present invention, the authentication interface presented may be a specific challenge question specified by the sender of the message. For example, the sender may have provided at least one challenge question and answer pair associated with the message, and the user attempting to access the message must provide the correct answer to the challenge question before accessing the message.

In one embodiment, the web interface also allows the users to perform various actions on a message displayed by the interface. For example, the user may forward, reply to, or delete a message. In one embodiment, the interface component 310 also may allow the user to compose a new message to be processed by communication system 100.

In addition, the interface component 310 may display attributes or other information related to the message as part of the web interface. For example, the attributes may include date and time stamps that indicate when the message was sent, processed, accessed, or modified or the IP address or other information about the computer or user from which messages were received. The information also may include attributes associated with any files attached to the message. Further, the interface component 310 also may provide controls via the interface that allow the user to add or remove file attachments or modify the message. For example, the user may modify the contents of the message, change delivery settings, including adding or removing message recipients, or delete the message. If a message has been modified, the interface component 310 may display information about the user(s) associated with the modifications. Such attributes may be graphical indications or text or any combination thereof. In one embodiment, deleting a message may permanently delete all copies of the message, such that messages stored by the communications system 100 that are associated with sending users, receiving users, or both may be removed.

The interface component 310 also enables authenticated users to view and manage previously received or sent communications messages. The interface component 310 may generate various views that arrange messages and associated attributes in an orderly manner. In an exemplary embodiment, the interface component 310 displays communications messages based according to the message type associated with the message. For example, interface component 310 may generate a view of “document” type messages that arranges the messages according to the documents associated with or attached to the message. In this view, the interface component 310 may display the attributes or message tag elements with the communications message so that the user may easily access the information.

In addition, the interface component 310 allows the user to specify data-retention policies. In one embodiment, the interface component 310 allows the user to specify a default setting that should be applied to messages created by the user. For example, the user may specify that the default data-retention rule should be to save all messages indefinitely. The user also may specify data-retention rules for individual messages, including an expiration time for the message or an event that causes the message to be purged. In one example, the user may specify that a particular message should be removed two days after the recipient has viewed the message.

In one embodiment, the interface component 310 may retrieve and access message data using a MAC 305. The MAC 305 communicates with interface component 310, encryption component 320, and external client interfaces using communications protocols, as described above. In one embodiment, the MAC 305 facilitates communications between the interface component 310 and other components of the system 100 using secure variants of IMAP, SMTP, or other protocols. In addition, the MAC 305 may use these or other protocols to facilitate communications between the system 100 and external email clients that users may use for creating and sending communications. In an exemplary embodiment, the MAC 305 facilitates communications between an email client, such as Microsoft Outlook or Mozilla Thunderbird or Internet browser-based client, and the system 100 using secure variants of IMAP and SMTP. In particular, the MAC 305 may provide message data, such as email header information and other limited information about the message contents, to the email client if such information is to be cached for local searching.

The MAC 305 also may facilitate access to individual messages requested by the email client over a secure connection established using the secure protocols, such as those discussed previously. In one example, communications messages are not stored locally by the email client. Instead, the MAC 305 transfers communications messages to the user's email client after receiving a request from the user to retrieve or access the communications message(s). In addition, the MAC 305 may facilitate access to content based on security or user settings. In particular, MAC 305 may provide message content in a form that cannot be copied easily or saved by the retrieving user. This feature may be used for a number of reasons, including confidentiality and security concerns if the contents of the message were saved by the retrieving user. For example, message content may be transformed into image data or encoded content that may be transmitted securely. In another embodiment, the MAC 305 facilitates communication between the interface component 310 and the encryption component 320.

In addition, the MAC 305 facilitates searching for messages by authenticated users via either an email client or the web interface. In one embodiment, the MAC 305 facilitates searching for matching communications messages based on keywords, message status, date, or message attributes. For example, the user may search for all messages created within the last week that remain unread by the recipient. In an exemplary embodiment, the MAC 305 may receive search terms from a user interacting with the system 100 via a secure connection established through an email client. Message headers and other limited information associated with messages may be cached by the email client, but the MAC 305 transmits messages matching the search query to the email client over the secure connection in accordance with the techniques previously described herein. In another embodiment, the MAC 305 receives a request for message data based on a user's interaction with a web interface. The searching described herein to identify messages may be accomplished by system 100 using any number of techniques well known in the art.

The encryption component 320 is configured to encrypt messages received by the communications system according to a default encryption setting or user-specified settings. Encryption algorithms used in processing messages may be any one of the many algorithms well known in the art, including symmetric algorithms and asymmetric algorithms. In one embodiment, the encryption component 320 may automatically process and encrypt received data and transfer the encrypted data to the database manager 330. The encryption component 320 also may apply user-defined settings to message data when processing messages. In an embodiment, the user-defined settings may specify the form of encryption, if any, used by the encryption component 320 and may include an encryption key or other credential supplied by the user that should be used to encrypt the data.

The database manager 330 provides secure storage for user and communications message information sent and received by the system 100. In particular, the database manager 330 interacts with encryption component 320 and interface component 310 to securely store information. For example, the encryption component 320 may provide the database manager 330 with rotating encryption information used to encrypt data. In one embodiment, the encryption information supplied by encryption component 320 may relate to a salt or key. In another embodiment, the encryption information may relate to the algorithm to be used. Also, the database manager 330 may oversee the operation of one or more database storage units 335 configured to store communications information. In one embodiment, stored communications information is distributed across multiple database units to facilitate access to the information stored therein. In addition, the database manager 330 may facilitate encryption of one or more database storage units 335 using techniques well known in the art with encryption component 320. In one embodiment, the database manager 330 may receive one or more encrypted messages then encrypt one or more database storage units 335 using a plurality of encryption keys. The encryption keys used to encrypt messages may be symmetric or asymmetric. For example, the database manager 330 may have a public-private key pair to encrypt information, where access to the private key is only available for certain processes running under the control of the database manager 330. In another embodiment, the encryption component 320 may encrypt data received from the database manager 330 and may transmit the encrypted data back to database manager 330. In addition, the database manager 330 may interact with the database storage units 335 using, for example, Structured Query Language (SQL).

In one embodiment, database storage units 335 may be implemented as one or more storage databases that include relational and non-relational, NoSQL databases that are accessed using SQL and various programmatic querying techniques. Embodiments may include some combination of database types that may include relational databases that provide indexing for a non-relational database implementation, such as MongoDB or other database implementations well known in the art.

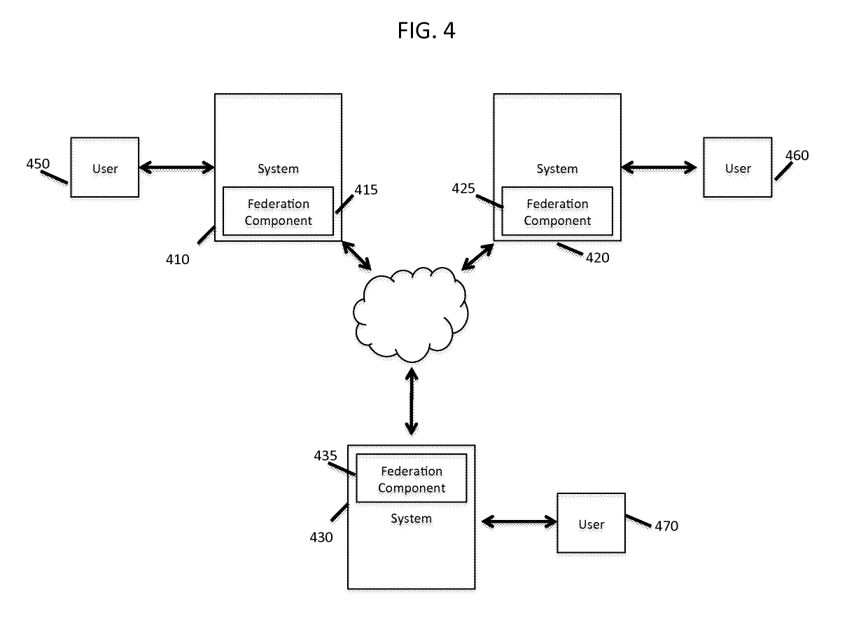

FIG. 4 illustrates one example of a federated system design in accordance with an embodiment of the present invention. The system 100 described above may be one of a plurality of systems, depicted herein as systems 410, 420, and 430, that are able to communicate over data networks. Such systems may be federated to provide a network of trusted systems that provide secure access to users' messages. In one embodiment, systems 410, 420, and 430 provide shared message access to users attempting to access messages stored on one or more of the systems. Federation components 415, 425, and 435 of systems 410, 420, and 430, respectively, handle inter-system communications for authentication and management. Authentication and management may be centralized, where one system in the federated network is designated as the leader, or may be distributed among the systems in the federated network.

In one example, user 450 may have an account associated with the system 410, but certain messages to which the user 450 desires access may be located on the system 420. The systems 410 and 420 may exchange data using their respective federation components 415 and 425, which may communicate using secure protocols, such as those discussed previously herein. The systems 420 and 430 provide access to messages without storing the message on both systems. More specifically, in one embodiment the system 420 may receive a message from user 460 and store and process that message according to the techniques described herein. When user 470 attempts to retrieve the message from his/her system 430, the system 420 facilitates access to the message because it is federated with the system 430. In one embodiment, federation component 435 may send a message request to system 420 regarding a message that user 470 wants to retrieve. In one embodiment, the request may also include authentication data related to the user 470 or system 430. The federation component 425 handles the request and interacts with other components of the system 410 to determine whether a matching message is stored locally. If a matching message is found, federation component 425 may provide access information to the federation component 435 to facilitate the user's 470 access to the stored information. In this manner, information storage does not have to be duplicated between trusted systems, but the user 470 receives the requested information without any indication that the information was retrieved from the system 420, not the system 430.

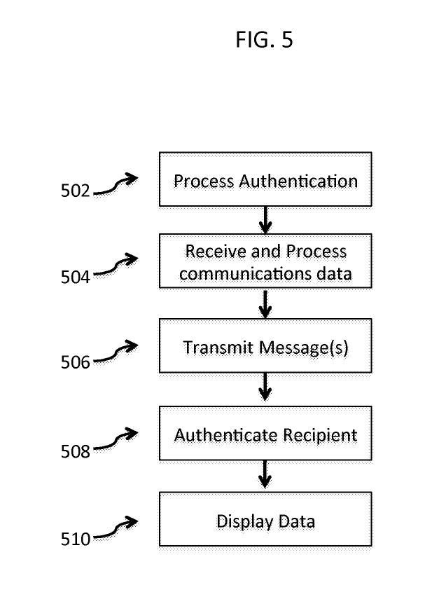

FIG. 5 depicts a method for managing secure communications consistent with an embodiment of the present invention. At 502, the communications system processes the authentication elements provided by the user. In one embodiment, the system may process authentication elements, such as a user name and password, from a user. In one embodiment, the authentication elements are received through a web interface. In another embodiment, the authentication elements are received from a software application configured to connect with the communication system using secure communications protocols, such as those discussed herein. In processing the authentication elements, the system may communicate with third-party systems that support one or more third-party authentication frameworks, but the system also may verify the authentication elements locally. In an exemplary embodiment, the system may use a third-party authentication framework, such as those discussed previously herein, to verify the authentication elements.

At 504, the communications system receives and processes communications data from the user. For example, the system may receive data packets related to a communications message. The data packets may be received using secure protocols such as those discussed herein above. In processing the data packets, the communications system may encrypt and store data in at least one connected database.

At 506, the communications system transmits at least one communications message to at least one recipient. In one embodiment, the communications system may transmit a notification message to the at least one recipient. The notification message may be transmitted via a standard messaging protocol. In another embodiment, the communication system may transmit a communications message containing secure content or content that may be configured to contain secure content.

At 508, the communications system authenticates the recipient of the message. In an exemplary embodiment, the system receives authentication credentials in the form of a user name and password combination that the communications system uses to authenticate the recipient if the recipient was not previously authenticated. The communications system may communicate with third-party systems to process the authentication credentials as part of its authentication step as discussed previously.

At 510, the communications system provides secure data elements to the recipient. In one embodiment, the communications system may display an email message as an element of a graphical user interface displayed as content in an Internet browser application on the recipient's computer. For example, secure message content may be integrated with other content as part of the graphical user interface in the Internet browser. The content may be integrated using a code snippet, such as JavaScript, configured to communicate with the communications system to retrieve the secure data and display the secure content as part of the graphical user interface. In another embodiment, the communications system transmits secure data elements to be contained within an existing communications message. The secure data elements may be displayed in an email client application in another embodiment.

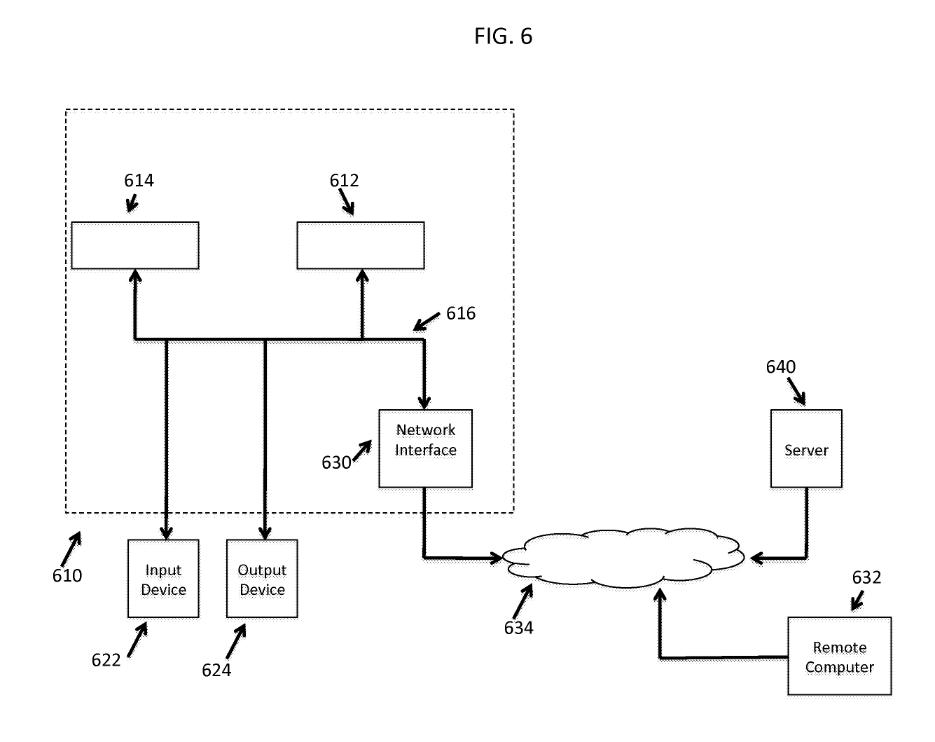

FIG. 6 illustrates a computer system implementing aspects of the present invention. In particular, computer 610 can be any computing device, such as a desktop computer, laptop computer, or handheld mobile device, configured to connect to the Internet. The computer 610 includes a processing component 612, memory 614, and a system bus 616. It is to be understood that the processing component 612 may comprise various processor designs that may include multiple processors. The system bus 616 provides a connection between system components, such as the processing component 612 and memory 614. The system bus may be any one of a number of designs that are well known in the art. The memory 614 may include any combination of volatile and non-volatile memory types of random access memory (RAM) and read-only memory (ROM) and other computer-readable media operable to store and facilitate transfer of computer-executable instructions and computer data, such as the software code associated with the present invention. The computer 610 also includes input devices 622 and output devices 624. The input devices 622 may include interaction devices such a keyboard, mouse, or touchpad configured to communicate with components of computer 610 via at least one input/output controller or interface. The output devices 624, such as a monitor, may display elements related to the functions of the present invention in a graphical format.

The computer 610 also includes a network interface 630, which is any interface suitable to physically link computer 610 with various networks to allow the computer 610 to connect to remote computers, such as remote computer 632. The network interface 630 may be configured to connect to various networks 634, such as local-area networks (LAN) and wide-area networks (WAN) using various communications technologies. In particular, the network interface 630 may utilize wired and wireless network protocols to connect to various networks and remote systems connected thereto. The computer 610 may be operably connected to at least one server 640 via the network interface 630 and the networks 634 and may exchange data packets therewith. Such data packets may be related to data stored or processed by the server(s) 640 that may be further processed or otherwise utilized by the computer 610. Server(s) 640 may be configured to include similar features as computer 610 with regard to components and functionality, as would be well understood to one having ordinary skill in the art. Computer 610 and server(s) 640 may be servers, workstations, personal computers, or other computing devices configured to communicate via network 634. The hardware architectures of other computing devices are to be used by way of examples, individually or networked together, and are materially similar to that of computer 610, and will therefore not be further detailed.

The flowchart and block diagrams in the figures illustrate the architecture, functionality, and operation of some possible implementations of systems, method, and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending on the functionality involved.

The invention can take the form of an entirely hardware embodiment, an entirely software embodiment, or an embodiment containing both hardware and software elements. In a preferred embodiment, the invention is implemented in software as computer executable instructions, which includes but is not limited to firmware, resident software, microprocessor code, etc.

Furthermore, the invention can take the form of a computer program product accessible from a computer-usable or computer-readable medium providing program code for use by or in connection with a computer or any instruction-execution system. For the purposes of this description, a computer-usable or computer-readable medium can be any tangible apparatus that can contain, store, communicate, propagate, or transport the program for use by or in connection with the instruction execution system, apparatus, or device.

It will be appreciated that a novel communications system and method have been described for enabling parties to transmit and receive information in a manner that preserves confidentiality and ensures security. The examples described herein are merely some embodiments of the present invention. These examples are not intended to limit the scope of the present invention, since it is not possible to enumerate every possible combination of components or methodologies associated with a description of the present invention. Those having ordinary skill in the art may recognize that other combinations or arrangements of the present invention are possible, and the present invention is meant to include all such variations. The invention as described herein contemplates all such embodiments as may come within the scope of the following claims and equivalents thereof. Furthermore, where the term “includes” has been used herein, either in the claims or in the detailed description, it is intended to be equivalent to the term “comprising” when that term is used as a transitional word in a claim.

1. A server device for facilitating secure communications, comprising:
a memory configured to store at least one data packet;
a processor operatively coupled to the memory and configured to:
identify an authentication framework to verify authentication data;
authenticate a user using the identified authentication framework;
securely receive message data associated with at least one communications message;
generate at least one outgoing message based at least in part on the received communications message, wherein the outgoing message differs from the received communications message; and
provide secure access to content associated with the at least one communications message.

2. The server device of claim 1, wherein identifying an authentication framework comprises determining whether the user authentication data is associated with a local account or an external account.

3. The server device of claim 1, wherein authenticating the user authentication data comprises:
forwarding the user authentication data to an external authentication server; and
receiving an authentication determination from the external authentication server.

4. The server device of claim 3, wherein receiving an authentication determination comprises establishing a secure connection with the user based at least in part on the verified authentication data.

5. The server device of claim 1, wherein the outgoing message is configured to include a hyperlink to facilitate access to the at least one communications message.

6. The server device of claim 1, wherein the processor is further configured to process a request associated with content in the outgoing message.

7. The server device of claim 6, wherein processing a request further comprises:
determining whether authentication information associated with a second user has been received;
generating content associated with the outgoing message based at least in part on an authentication status of the second user; and
securely transmitting the generated content.

8. The server device of claim 1, wherein identifying an authentication framework comprises processing at least one of a user name or email address.

9-18. (canceled)

19. A method for secure communications, comprising:
identifying, using a processor, an authentication framework to verify authentication data;
authenticating, using the processor, a user using the identified authentication framework;
receiving message data associated with at least one communications message;
generating at least one outgoing message in response to the received message data, wherein the outgoing message differs from the received communications message; and
providing access to content associated with the at least one communications message.

20. The method of claim 19, wherein identifying an authentication framework comprises determining whether the user authentication data is associated with a local account or an external account.

21. The method of claim 19, wherein authenticating the user authentication data comprises:
forwarding the user authentication data to an external authentication server; and
receiving an authentication determination from the external authentication server.

22. The method of claim 21, wherein receiving an authentication determination comprises establishing a secure connection with the user based at least in part on the verified authentication data.

23. The method of claim 19, wherein the outgoing message is configured to include a hyperlink to facilitate access to the at least one communications message.

24. The method of claim 19, further comprising processing a request associated with content in the outgoing message.

25. The method of claim 24, wherein processing a request further comprises:
determining whether authentication information associated with a second user has been received; and
generating content associated with the outgoing message based at least in part on an authentication status of the second user; and
securely transmitting the generated content.

26. The method of claim 19, wherein identifying an authentication framework comprises processing at least one of a user name or email address.

27. A non-transitory computer-readable medium having computer-readable instructions stored thereon, the instructions comprising:
instructions for identifying an authentication framework to verify authentication data;
instructions for authenticating a user using the identified authentication framework;
instructions for receiving message data associated with at least one communications message;
instructions for generating at least one outgoing message in response to the received message data, wherein the outgoing message differs from the received communications message; and
instructions for providing access to content associated with the at least one communications message.
